(19) United States
(12) Patent Application Publication
(10) Pub. No.: US 2022/0162443 A1
(43) Pub. Date: May 26, 2022

(54) THERMOPLASTIC POLYURETHANE COMPOSITION, GOLF BALL, AND METHOD FOR MAKING GOLF BALL

(71) Applicant: LAUNCH TECHNOLOGIES CO., LTD., Pingtung City (TW)

(72) Inventors: Ping-Hsiu SHIH, Pingtung City (TW); Tsai-Shi LIU, Pingtung City (TW); Kuan-Hao CHENG, Pingtung City (TW); Liang-Ho TSAI, Pingtung City (TW)

(21) Appl. No.: 17/104,697

(22) Filed: Nov. 25, 2020

(51) Int. Cl. C08L 75/04; C08K 3/22; C08K 7/02; A63B 37/00; B29C 39/10; B29C 39/26

(52) U.S. Cl. CPC C08L 75/04; C08K 3/22; C08K 7/02; A63B 37/00221; B05D 2503/00; B29C 39/26; C08K 2003/2241; C08K 2201/003; B29C 39/10

(57) ABSTRACT

A thermoplastic polyurethane composition includes a first elastomer, a second elastomer, and a third elastomer. The first elastomer includes a first material and a plurality of fiber elements. The second elastomer includes a second material. The third elastomer includes a third material and an additive. Each of the first, second, and third materials is one of polyester-based thermoplastic polyurethane, polyether-based thermoplastic polyurethane, polycarbonate-based thermoplastic polyurethane, or combinations thereof. A golf ball and a method for making the golf ball are also provided herein.

### FIELD

The disclosure relates to a composition, a golf ball, and a method for making the golf ball, and more particularly to a thermoplastic polyurethane composition, a golf ball, and a method for making the golf ball.

### BACKGROUND

A golf ball generally includes a core, a shell, and an intermediate layer between the core and the shell. The shell of a common high-end golf ball is mainly made of a thermosetting polyurethane elastomer. However, manufacturing process of such shell is time-consuming, and since the thermosetting polyurethane elastomer is difficult to be recycled, the shell made therefrom is usually discarded as waste after use.

### SUMMARY

Therefore, an object of the disclosure is to provide a novel thermoplastic polyurethane composition for making a shell of a golf ball, which can overcome at least one drawback of the prior art. A golf ball made from the thermoplastic polyurethane composition and a method for making the golf ball are also provided.

According to a first aspect of the disclosure, a thermoplastic polyurethane composition includes a first elastomer, a second elastomer, and a third elastomer.

The first elastomer is present in an amount ranging from 10 wt % to 60 wt % based on a total weight of the thermoplastic polyurethane composition, and includes a first material and a plurality of fiber elements.

The first material is selected from the group consisting of polyester-based thermoplastic polyurethane, polyether-based thermoplastic polyurethane, polycarbonate-based thermoplastic polyurethane, and combinations thereof, and is present in an amount ranging from 90 wt % to 95 wt % based on the total weight of the first elastomer.

The fiber elements are present in an amount ranging from 5 wt % to 10 wt % based on the total weight of the first elastomer.

The second elastomer is present in an amount ranging from 30 wt % to 65 wt % based on the total weight of the thermoplastic polyurethane composition, and includes a second material selected from the group consisting of polyester-based thermoplastic polyurethane, polyether-based thermoplastic polyurethane, polycarbonate-based thermoplastic polyurethane, and combinations thereof.

The third elastomer is present in an amount ranging from 6 wt % to 50 wt % based on the total weight of the thermoplastic polyurethane composition, and includes a third material and an additive.

The third material is selected from the group consisting of polyester-based thermoplastic polyurethane, polyether-based thermoplastic polyurethane, polycarbonate-based thermoplastic polyurethane, and combinations thereof, and is present in an amount ranging from 85 wt % to 98 wt % based on the total weight of the third elastomer.

The additive is made of a material selected from the group consisting of titanium dioxide, antioxidant, anti-yellowing agent, and combinations thereof, and is present in an amount ranging from 2 wt % to 15 wt % based on the total weight of the third elastomer.

According to a second aspect of the disclosure, a golf ball includes a core, a shell, and an intermediate layer disposed between the core and the shell. The shell is made from the abovementioned thermoplastic polyurethane composition.

According to a third aspect of the disclosure, a method for making the abovementioned golf ball includes the steps of:

i) subjecting a rubber material to thermal molding so as to form the core;

ii) forming the intermediate layer to encapsulate the core so as to obtain an intermediate product;

iii) heating the thermoplastic polyurethane composition to a predetermined temperature so as to obtain a melted composition;

iv) positioning the intermediate product in a mold cavity of a mold; and

v) after step iv), introducing the melted composition to the mold cavity to form the shell on the intermediate product so as to obtain a ball product.

### BRIEF DESCRIPTION OF THE DRAWINGS

Other features and advantages of the disclosure will become apparent in the following detailed description of the embodiments with reference to the accompanying drawings, of which:

FIG. 1 is a schematic view illustrating how a golf ball is made by a method according to an embodiment of the disclosure; and

FIG. 2 is a flow chart illustrating the steps of the method for making the golf ball.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

According to an embodiment of the disclosure, a thermoplastic polyurethane composition includes a first elastomer, a second elastomer, and a third elastomer.

The first elastomer is present in an amount ranging from 10 wt % to 60 wt % based on a total weight of the thermoplastic polyurethane composition, and includes a first material and a plurality of fiber elements.

The first material is selected from the group consisting of polyester-based thermoplastic polyurethane, polyether-based thermoplastic polyurethane, polycarbonate-based thermoplastic polyurethane, and combinations thereof, and is present in an amount ranging from 90 wt % to 95 wt % based on the total weight of the first elastomer.

The fiber elements are present in an amount ranging from 5 wt % to 10 wt % based on the total weight of the first elastomer.

Each of the fiber elements is made of a material selected from the group consisting of fullerene fiber, melamine fiber, cellulose fiber, polyamide fiber, acetate fiber, viscose fiber, nylon fiber, elastane fiber, vinylon fiber, terylene fiber, acrylic fiber, polypropylene fiber, hemp fiber, cotton fiber, fruit fiber, asbestos fiber, glass fiber, metal fiber, wool fiber, silk fiber, carbon black fiber, polyacrylonitrile fiber, polyurethane fiber, polyester fiber, carbon fiber, and combinations thereof.

Each of the fiber elements may have a length ranging from 1.00 mm to 3.00 mm and may have an average diameter of 10 μm.

The first elastomer may be in a form of pellets. In an embodiment, the first material and the fiber elements may be blended and pelletized into pellets of the first elastomer which may have an average diameter ranging from 0.07 inch to 0.15 inch, and which may have a Shore A hardness ranging from 90 to 95.

The second elastomer is present in an amount ranging from 30 wt % to 65 wt % based on the total weight of the thermoplastic polyurethane composition, and includes a second material selected from the group consisting of polyester-based thermoplastic polyurethane, polyether-based thermoplastic polyurethane, polycarbonate-based thermoplastic polyurethane, and combinations thereof. The second elastomer may have a Shore A hardness ranging from 85 to 95.

The third elastomer is present in an amount ranging from 6 wt % to 50 wt % based on the total weight of the thermoplastic polyurethane composition, and includes a third material and an additive.

The third material is selected from the group consisting of polyester-based thermoplastic polyurethane, polyether-based thermoplastic polyurethane, polycarbonate-based thermoplastic polyurethane, and combinations thereof, and is present in an amount ranging from 85 wt % to 98 wt based on the total weight of the third elastomer.

The additive is made of a material selected from the group consisting of titanium dioxide, antioxidant, anti-yellowing agent, and combinations thereof, and is present in an amount ranging from 2 wt % to 15 wt % based on the total weight of the third elastomer.

In an embodiment, the third material and the additive may be blended and pelletized into pellets of the third elastomer which may have an average diameter ranging from 0.07 inch to 0.15 inch, and which may have a Shore A hardness ranging from 85 to 95.

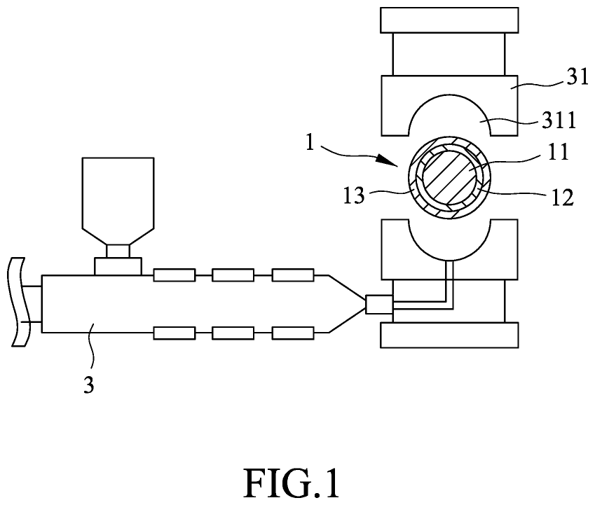

Referring to FIG. 1, a golf ball 1 according to an embodiment of the disclosure is shown to include a core 11, a shell 13, and an intermediate layer 12 disposed between the core 11 and the shell 13. The core 11 may be made of a rubber material. The shell 13 is made from the abovementioned thermoplastic polyurethane composition. The intermediate layer 12 may be made of ionized resin.

In an embodiment, the shell 13 may have a thickness ranging from 0.0311 inch to 0.0345 inch, and may be coated with an isocyanate compound.

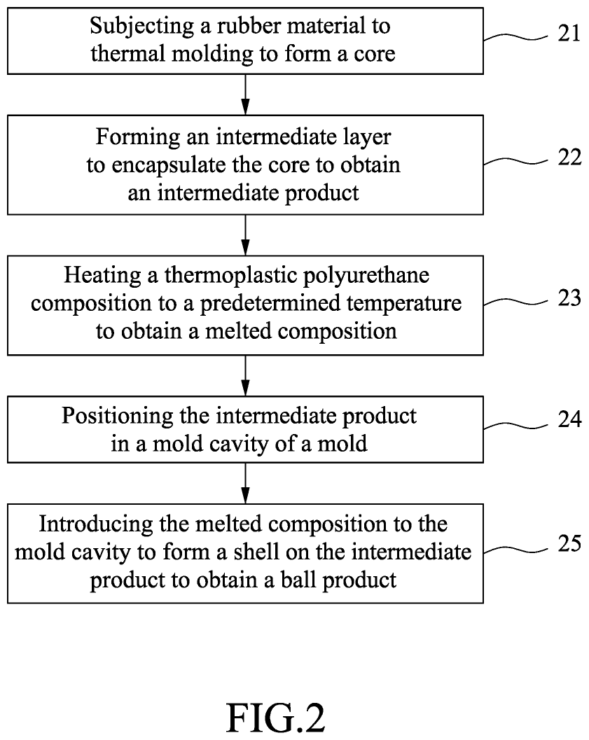

FIG. 2 illustrates the steps of a method for making the golf ball 1 shown in FIG. 1. The method includes steps 21 to 25.

In step 21, the abovementioned rubber material is subjected to thermal molding in a thermal molding machine (not shown), so as to form the core 11.

In step 22, the intermediate layer 12 is formed to encapsulate the core 11 so as to obtain an intermediate product. In an embodiment, the core 11 may be encapsulated with the abovementioned ionized resin using an injection molding machine to thereby form the intermediate layer 12.

In step 23, the thermoplastic polyurethane composition is heated to a predetermined temperature so as to obtain a melted composition. In an embodiment, a horizontal injection molding machine 3 is provided and set to the predetermined temperature, and the thermoplastic polyurethane composition is then introduced to the horizontal injection molding machine 3 and is heated to the predetermined temperature, so as to obtain the melted composition. In other embodiments, a vertical injection molding machine may be used instead of the horizontal injection molding machine 3.

In an embodiment, the thermoplastic polyurethane composition is prepared by mixing the pellets of the first elastomer (present in an amount ranging from 10 wt % to 60 wt %), the second elastomer (present in an amount ranging from 30 wt % to 65 wt %), and the pellets of the third elastomer (present in an amount ranging from 6 wt % to 50 wt %).

In an embodiment, the predetermined temperature may range from 230° C. to 240° C.

In step 24, the intermediate product is positioned in a mold cavity 311 of a mold 31 (see FIG. 1). Please note that, although step 24 is implemented after step 23 in the embodiment shown in FIG. 2, step 24 may be implemented before, after, or simultaneously with step 23.

Step 25 is implemented after steps 23 and 24. In step 25, the melted composition is introduced to the mold cavity 311 to form the shell 13 on the intermediate product so as to obtain a ball product. In an embodiment, the mold 31 may be kept at a temperature ranging from 30° C. to 40° C.

It should be noted that, after step 25, the method may further include the following consecutive steps 26 and 27:

In step 26, the ball product is immersed in an isocyanate solution for a period ranging from 3 minutes to 5 minutes. In an embodiment, the isocyanate compound in the isocyanate solution may have a concentration ranging from 1 wt % to 50 wt % based on a total weight of the isocyanate solution.

In step 27, the ball product is dried at a temperature ranging from 60° C. to 70° C. for a period ranging from 2 hours to 4 hours, so as to coat the isocyanate compound on the ball product.

In summary, by virtue of including the fiber elements in the shell 13 of the golf ball 1, the strength and surface toughness of the shell 13 can be enhanced, so as to increase cutting resistance of the golf ball 1. In addition, the period for manufacturing the thermoplastic polyurethane composition is relatively short and the materials thereof can be recycled.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A thermoplastic polyurethane composition, comprising:
a first elastomer which is present in an amount ranging from 10 wt % to 60 wt % based on a total weight of said thermoplastic polyurethane composition, and which includes
a first material which is selected from the group consisting of polyester-based thermoplastic polyurethane, polyether-based thermoplastic polyurethane, polycarbonate-based thermoplastic polyurethane, and combinations thereof, and which is present in an amount ranging from 90 wt % to 95 wt % based on the total weight of said first elastomer, and
a plurality of fiber elements present in an amount ranging from 5 wt % to 10 wt % based on the total weight of said first elastomer;
a second elastomer which is present in an amount ranging from 30 wt % to 65 wt % based on the total weight of said thermoplastic polyurethane composition, and which includes a second material selected from the group consisting of polyester-based thermoplastic polyurethane, polyether-based thermoplastic polyurethane, polycarbonate-based thermoplastic polyurethane, and combinations thereof; and
a third elastomer which is present in an amount ranging from 6 wt % to 50 wt % based on the total weight of said thermoplastic polyurethane composition, and which includes
a third material which is selected from the group consisting of polyester-based thermoplastic polyurethane, polyether-based thermoplastic polyurethane, polycarbonate-based thermoplastic polyurethane, and combinations thereof, and which is present in an amount ranging from 85 wt % to 98 wt % based on the total weight of said third elastomer, and
an additive which is made of a material selected from the group consisting of titanium dioxide, antioxidant, anti-yellowing agent, and combinations thereof, and which is present in an amount ranging from 2 wt % to 15 wt % based on the total weight of said third elastomer.

2. The thermoplastic polyurethane composition of claim 1, wherein said first elastomer has a Shore A hardness ranging from 90 to 95.

3. The thermoplastic polyurethane composition of claim 1, wherein each of said second elastomer and said third elastomer has a Shore A hardness ranging from 85 to 95.

4. The thermoplastic polyurethane composition of claim 1, wherein each of said fiber elements has a length ranging from 1.00 mm to 3.00 mm.

5. The thermoplastic polyurethane composition of claim 1, wherein each of said fiber elements has an average diameter of 10 μm.

6. The thermoplastic polyurethane composition of claim 1, wherein each of said fiber elements is made of a material selected from the group consisting of fullerene fiber, melamine fiber, cellulose fiber, polyamide fiber, acetate fiber, viscose fiber, nylon fiber, elastane fiber, vinylon fiber, terylene fiber, acrylic fiber, polypropylene fiber, hemp fiber, cotton fiber, fruit fiber, asbestos fiber, glass fiber, metal fiber, wool fiber, silk fiber, carbon black fiber, polyacrylonitrile fiber, polyurethane fiber, polyester fiber, carbon fiber, and combinations thereof.

7. A golf ball, comprising a core, a shell, and an intermediate layer disposed between said core and said shell, said shell being made from the thermoplastic polyurethane composition as claimed in claim 1.

8. The golf ball of claim 7, wherein said shell has a thickness ranging from 0.0311 inch to 0.0345 inch.

9. The golf ball of claim 7, wherein said intermediate layer is made of ionized resin.

10. The golf ball of claim 7, wherein said shell is coated with an isocyanate compound.

11. A method for making a golf ball as claimed in claim 7, comprising the steps of:
i) subjecting a rubber material to thermal molding so as to form the core;
ii) forming the intermediate layer to encapsulate the core so as to obtain an intermediate product;
iii) heating the thermoplastic polyurethane composition to a predetermined temperature so as to obtain a melted composition;
iv) positioning the intermediate product in a mold cavity of a mold; and
v) after step iv), introducing the melted composition to the mold cavity to form the shell on the intermediate product so as to obtain a ball product.

12. The method of claim 11, wherein the predetermined temperature in step iii) ranges from 230° C. to 240° C., and the mold in step v) is kept at a temperature ranging from 30° C. to 40° C.

13. The method of claim 11, wherein each of the first elastomer and the third elastomer is in a form of pellets having an average diameter ranging from 0.07 inch to 0.15 inch.

14. The method of claim 11, after step v), further comprising the steps of:
vi) immersing the ball product in an isocyanate solution for a period ranging from 3 minutes to 5 minutes; and
vii) after step vi), drying the ball product at a temperature ranging from 60° C. to 70° C. for a period ranging from 2 hours to 4 hours so as to coat an isocyanate compound on the ball product.
